(19) United States
(12) Patent Application Publication
(10) Pub. No.: US 2005/0184984 A1
(43) Pub. Date: Aug. 25, 2005

(54) Display apparatus and control method thereof

(75) Inventor: Kwang-youn Kim, Suwon-Si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/060,508

(22) Filed: Feb. 18, 2005

(30) Foreign Application Priority Data
Feb. 20, 2004 (KR) 2004-11347

(51) Int. Cl. G09G 5/00; G06F 1/26

(52) U.S. Cl. 345/211; 713/340

(57) ABSTRACT

A display apparatus including a power supply, a microcomputer that receives electric power from the power supply and controls predetermined internal functional elements, a level change checker that checks whether a voltage level of the electric power is outside a predetermined allowable voltage-level range; and a controller that resets the microcomputer when the level change checker determines that the voltage level of the electric power is outside the allowable voltage-level range more than a predetermined number of times within a predetermined period of time. With this configuration, the present invention provides a display apparatus and a control method thereof, in which a microcomputer is reset when unstable power supplying is repeated more than a predetermined number of times within a predetermined period of time.

### CROSS-REFERENCE TO RELATED APPLICATIONS

This application claims the benefit of Korean Patent Application No. 2004-11347, filed Feb. 20, 2004, in the Korean Intellectual Property Office, the disclosure of which is incorporated herein by reference.

### BACKGROUND OF THE INVENTION

1. Field of the Invention

The present invention relates to a display apparatus and a control method thereof, and more particularly, to a display apparatus and a control method thereof, in which a microcomputer is reset when an unstable power supply is repeated more than a predetermined number of times within a predetermined period of time.

2. Description of the Related Art

Generally, a display apparatus comprises a microcomputer, and various functional elements that implement a specific function.

The microcomputer is a main controller that controls the functional elements that implement specific functions. Therefore, all functions of the display apparatus are implemented normally when the microcomputer is operated normally, and the functions of the display apparatus are implemented abnormally when the microcomputer is not operated normally. That is, the display apparatus is not operated normally when the microcomputer is operated abnormally.

The microcomputer is operated normally when electric power having a predetermined voltage is stably supplied, but the microcomputer may be operated abnormally when the voltage of the electric power is unstable.

However, when the voltage of the electric power is unstable, particularly, when a power supply connected to an external alternating current (AC) power source is turned on and off repeatedly within a relatively short period of time, there is a point of time at which the power supply supplies the electric power having a low voltage to the microcomputer because of the charging and discharging time of the power. At this time, the microcomputer that received the electric power having the low voltage cannot be normally operated.

As the microcomputer starts to operate abnormally, the program often gets caught in an infinite loop and the abnormally executed program is repeated infinitely. Therefore, on a screen a picture is not displayed or an abnormal picture is displayed.

### SUMMARY OF THE INVENTION

Accordingly, it is an aspect of the present invention to provide a display apparatus and a control method thereof, in which a microcomputer is reset when an unstable power supplying is repeated more than a predetermined number of times within a predetermined period of time.

Additional aspects and/or advantages of the invention will be set forth in part in the description which follows and, in part, will be obvious from the description, or may be learned by practice of the invention.

The foregoing and/or other aspects of the present invention are achieved by providing a display apparatus comprising a power supply, a microcomputer that receives electric power from the power supply and controls predetermined internal functional elements, a level change checker that checks whether a voltage level of the electric power is outside a predetermined allowable voltage-level range; and a controller that resets the microcomputer when the level change checker determines that the voltage level of the electric power is outside the allowable voltage-level range more than a predetermined number of times within a predetermined period of time.

According to an aspect of the invention, the level change checker comprises: a power input part through which the electric power is inputted; an allowable voltage-level setting part in which the allowable voltage-level range is set; a comparator that determines whether the voltage level of the electric power is within the allowable voltage-level range on the basis of the allowable voltage-level range set in the allowable voltage-level setting part; and an output part that outputs an abnormal signal to the controller when the comparator determines that the voltage level of the electric power being supplied to the power input part is outside the allowable voltage-level range.

According to an aspect of the invention, the controller outputs a reset signal to reset the microcomputer when the level change checker checks that the voltage level of the electric power is outside the allowable voltage-level range more than two or three times during a 200 ms time period.

According to another aspect of the present invention, the above and/or other aspects may be also achieved by providing a method of controlling a display apparatus comprising a power supply, and a microcomputer that receives electric power from the power supply and controls predetermined internal functional elements. The method comprising: checking whether a voltage level of the electric power supplied from the power supply is outside a predetermined allowable voltage-level range; counting how many times the voltage level of the electric power is outside the allowable voltage-level range; and resetting the microcomputer when the voltage level of the electric power is outside the allowable voltage-level range more than a predetermined number of times within a predetermined period of time.

### BRIEF DESCRIPTION OF THE DRAWINGS

These and other aspects and advantages of the present invention will become apparent and more readily appreciated from the following description of the embodiments, taken in conjunction with the accompany drawings of which:

FIG. 1 is a block diagram of a display apparatus according to an embodiment of the present invention; and

FIG. 2 is a control flowchart of the display apparatus according to an embodiment of the present invention.

### DETAILED DESCRIPTION OF THE PREFERRED EMBODIMENT

Reference will now be made in detail to the embodiments of the present invention, examples of which are illustrated in the accompanying drawings, wherein like reference numerals refer to like elements throughout. The embodiments are described below in order to explain the present invention by referring to the figures.

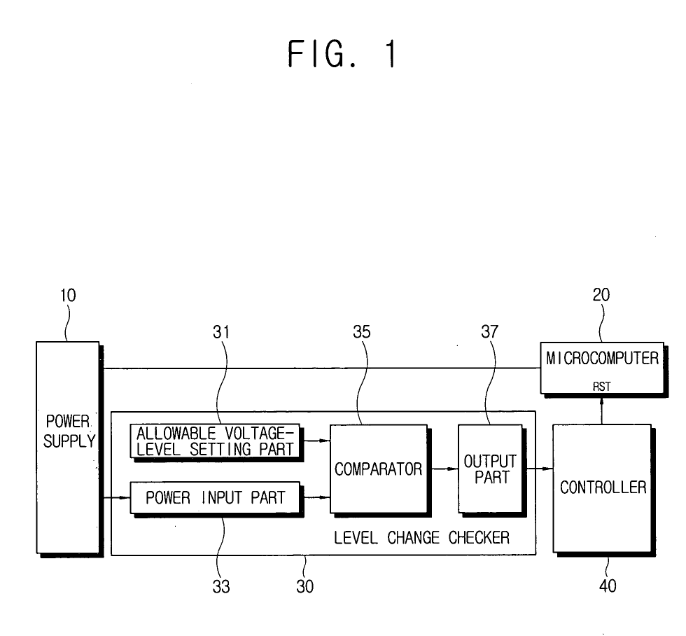

As shown in FIG. 1, a display apparatus according to an embodiment of the present invention comprises a power supply 10, a microcomputer 20, a level change checker 30, and a controller 40. The level change checker 30 comprises a power input part 33, an allowable voltage-level setting part 31, a comparator 35, and an output part 37.

The microcomputer 20 receives electric power from the power supply 10 and controls predetermined internal functional elements.

The level change checker 30 checks whether or not a voltage level of the electric power supplied to the microcomputer 20 is beyond a predetermined allowable voltage-level range.

Specifically, the electric power is supplied to the power input part 33. The allowable voltage-level range of the electric power is previously set in the allowable voltage-level setting part 31. Then, the comparator 35 determines whether the voltage level of the supplied electric power is within the allowable voltage-level range on the basis of the allowable voltage-level range set in the allowable voltage-level setting part 31. When the comparator 35 determines that the voltage level of the electric power being supplied to the power input part 33 is outside the allowable voltage-level range, the output part 37 outputs an abnormal signal to the controller 40.

For example, if the microcomputer 20 is normally operated at a reference voltage level of 5V, the electric power having a voltage level of 5V should be supplied from the power supply 10 to the microcomputer 20.

In this case, if the allowable voltage-level range is previously set as 5% in the allowable voltage-level setting part 31 of the level change checker 30, a voltage level of the electric power is within the allowable voltage-level range when a voltage level of 4.75V-5.25V is supplied to the power input part 33. Alternately, in the case where the allowable voltage-level range is set as 10%, the electric power having a voltage level of 4.5V-5V may be allowed to be supplied. That is, even if the voltage is unstable, the voltage level at which the microcomputer 20 normally operates is considered when setting the allowable voltage-level range in the allowable voltage-level setting part 31.

On the other hand, when the voltage level of the electric power being supplied from the power supply 10 is outside the allowable voltage-level range, for example, when the electric power having a voltage level of 3.25V is supplied in the foregoing case, the comparator 35 determines the voltage level of 3.25V is outside the allowable voltage-level range on the basis of an allowable voltage-level range of 10%.

At this time, the output part 37 outputs the abnormal signal to the controller 40 on the basis of the determined result of the comparator 35, thereby transmitting information that the voltage of the electric power supplied from the power supply 10 is unstable and thus the microcomputer 20 may be abnormally operated.

Further, when the level change checker 30 determines that the voltage level of the electric power is outside the allowable voltage-level range more than a predetermined number of times within a predetermined period of time, the controller 40 resets the microcomputer 20.

For example, the controller 40 controls the level change checker 30 to check whether the electric power is outside the allowable voltage-level range. The level change checker 30 checks the voltage level twenty times during a 200 ms time period. At this time, in the case where the abnormal signal is outputted two or three times during 200 ms, the controller 40 outputs a reset signal to reset the microcomputer 20. Further, in the case where there is no abnormal signal or the abnormal signal is outputted once during 200 ms, the controller 40 again controls the level change checker 30 to check twenty times whether the electric power is outside the allowable voltage-level range during a 200 ms time period.

Alternately, the present invention may be achieved by allowing the controller 40 to start counting the time elapsed after a first abnormal signal is output from the level change checker 30. In this case, if an abnormal signal is outputted once or twice when 200 ms have passed since the first abnormal, that is, if the abnormal signal is outputted at total of two or three times during 200 ms, the controller 40 outputs a reset signal to reset the microcomputer 20. Then, the controller 40 again starts counting the time elapsed after a new abnormal signal is output from the level change checker 30.

Meanwhile, the level change checker 30 checks whether the voltage level of the electric power is outside the allowable voltage-level range. Thus, the output part 37 of the level change checker 30 outputs the abnormal signal to the controller 40 when the comparator 35 determines that the voltage level of the electric power being supplied to the power input part 33 is outside the allowable voltage-level range.

In this case, when the controller 40 receives the abnormal signal from the level change checker 30 more than a predetermined number of times within a predetermined period of time, the controller 40 outputs the reset signal to the microcomputer 20 in order to reset the microcomputer 20.

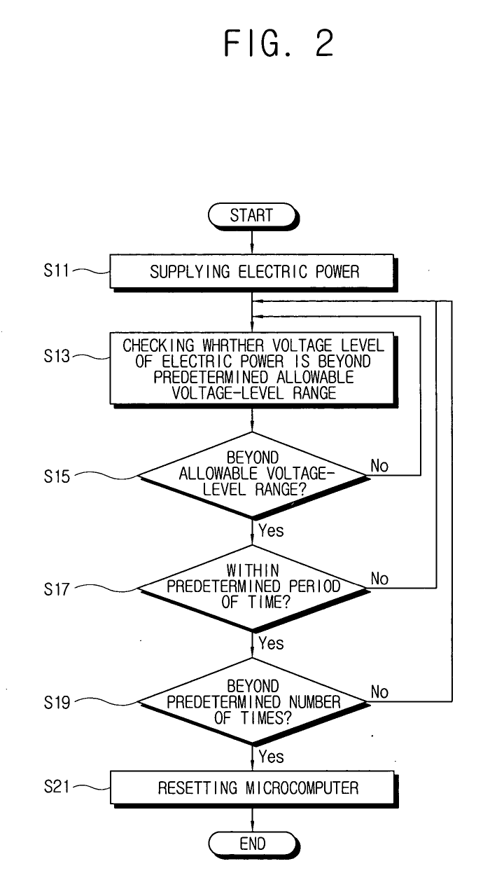

Hereinbelow, a control flowchart of the display apparatus according to an embodiment of the present invention will be described with reference to FIG. 2.

At operation S11, the display apparatus receives the electric power through the power supply 10, and then at operation S13, the level change checker 30 checks whether the voltage level of the electric power is outside the allowable voltage-level range.

Here, the level change checker 30 comprises the power input part 33, the allowable voltage-level setting part 31, the comparator 35, and the output part 37. Further, the level change checker 30 outputs the abnormal signal to the controller 40 through the output part 37 when the comparator 35 determines that the voltage level of the electric power being supplied to the power input part 33 is outside the allowable voltage-level range previously set in the allowable voltage-level setting part 31.

At operations S15 and S17, in the case where the controller 40 receives the abnormal signal during the time, the controller 40 checks how may times the abnormal signal is received from the level change checker 30. At operation S19, when the controller 40 receives the abnormal signal from the level change checker 30 more than the number of times during the predetermined time, at operation S21, the controller 40 outputs the reset signal to the microcomputer 20 in order to reset the microcomputer 20.

Alternately, at operation S15, when the controller 40 first receives the abnormal signal from the level change checker 30, the controller 40 starts counting the elapsed time. Then, at operations S17 and S19, in the case where the abnormal signals are outputted more than a predetermined number of times when a predetermined time period has passed since the first abnormal signal, at operation S21, the controller 40 outputs the reset signal to reset the microcomputer 20. Thereafter, the controller 40 starts again counting the time elapsed after a new abnormal signal is output from the level change checker 30.

Further, at operations S15, S17 and S19, when the level change checker 30 determines that the voltage level of the electric power is outside the allowable voltage-level range, and the controller 40 receives the abnormal signal from the level change checker 30, more than a predetermined number of times within a predetermined period of time, the controller 40 outputs the reset signal to the microcomputer 20. Then, at operation S21, the microcomputer 20 is reset by the reset signal.

As described above, the present invention provides a display apparatus and a control method thereof, in which a microcomputer is reset when unstable power supplying is repeated more than a predetermined number of times within a predetermined period of time.

Although a few embodiments of the present invention have been shown and described, it will be appreciated by those skilled in the art that changes may be made in these embodiments without departing from the principles and spirit of the invention, the scope of which is defined in the appended claims and their equivalents.

1. A display apparatus, comprising:
a power supply,
a microcomputer that receives electric power from the power supply and controls predetermined internal functional elements,
a level change checker that checks whether a voltage level of the electric power is outside a predetermined allowable voltage-level range; and
a controller that resets the microcomputer when the level change checker determines that the voltage level of the electric power is outside the allowable voltage-level range more than a predetermined number of times within a predetermined period of time.

2. The display apparatus according to claim 1, wherein the level change checker comprises:
a power input part through which the electric power is inputted;
an allowable voltage-level setting part in which the allowable voltage-level range is set;
a comparator that determines whether the voltage level of the electric power is within the allowable voltage-level range on the basis of the allowable voltage-level range set in the allowable voltage-level setting part; and
an output part that outputs an abnormal signal to the controller when the comparator determines that the voltage level of the electric power being supplied to the power input part is outside the allowable voltage-level range.

3. The display apparatus according to claim 1, wherein the controller outputs a reset signal to reset the microcomputer when the level change checker determines that the voltage level of the electric power is outside the allowable voltage-level range more than two times during a 200 ms time period.

4. The display apparatus according to claim 1, wherein the controller outputs a reset signal to reset the microcomputer when the level change checker determines that the voltage level of the electric power is outside the allowable voltage-level range more than three times during a 200 ms time period.

5. The display apparatus according to claim 2, wherein the controller outputs a reset signal to reset the microcomputer when the level change checker determines that the voltage level of the electric power is outside the allowable voltage-level range more than two times during a 200 ms time period.

6. The display apparatus according to claim 2, wherein the controller outputs a reset signal to reset the microcomputer when the level change checker determines that the voltage level of the electric power is outside the allowable voltage-level range more than three times during a 200 ms time period.

7. A method of controlling a display apparatus, the display apparatus comprising a power supply, and a microcomputer that receives electric power from the power supply and controls predetermined internal functional elements, the method comprising:
checking whether a voltage level of the electric power supplied from the power supply is outside a predetermined allowable voltage-level range;
counting how many times the voltage level of the electric power is outside the allowable voltage-level range; and
resetting the microcomputer when the voltage level of the electric power is outside the allowable voltage-level range more than a predetermined number of times for a predetermined period of time.

8. The method according to claim 7, wherein the microcomputer is reset when the voltage level of the electric power is outside the allowable voltage-level range more than two times during a 200 ms time period.

9. The method according to claim 7, wherein the microcomputer is reset when the voltage level of the electric power is outside the allowable voltage-level range more than three times during a 200 ms time period.
